(19) United States
(12) Patent Application Publication
(10) Pub. No.: US 2014/0372067 A1
(43) Pub. Date: Dec. 18, 2014

(54) DEVICE FOR TESTING TILT ANGLE OF MACHINE CABINET

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: JIAN-FENG TIE, Shenzhen (CN)

(21) Appl. No.: 14/302,894

(22) Filed: Jun. 12, 2014

(30) Foreign Application Priority Data
Jun. 14, 2013 (CN) 2013102348664

(51) Int. Cl. G01C 9/02

(52) U.S. Cl. CPC G01C 9/02
USPC 702/113

(57) ABSTRACT

A device for testing tilt angles of tilt of a cabinet includes an angle tester, a controller, and a driver. The angle tester senses a tilt angle of the machine cabinet. The controller includes a processor and a preset angle module. The preset angle module is connected to the processor and stores a preset angle. The processor controls the driver to lift up a side of the machine cabinet. If the cabinet does not topple, the driver keeps lifting up the side of the machine cabinet until the tilt angle equals the preset angle, and the cabinet is deemed to meet a standard.

### FIELD

The present disclosure relates to a device for testing a tilt angle of a machine cabinet.

### BACKGROUND

A cabinet usually accepts a plurality of computers or control equipments. In order to be aware of safety limits in a process of transporting or carrying, a certain tilt angle of the cabinet needs to be tested in manufacture, to see whether the cabinet meets a standard.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a device connected to a machine cabinet.

FIG. 2 illustrates an embodiment of a driver of the device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

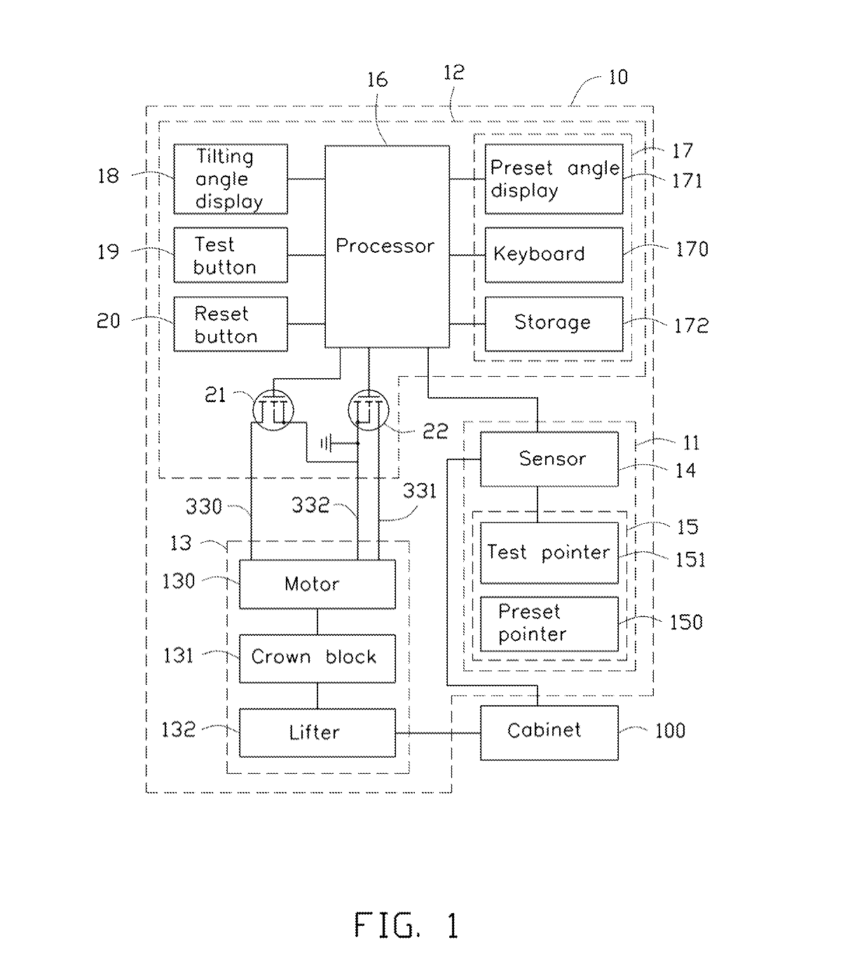

FIG. 1 is a block diagram of an embodiment of a device 10 applied to a machine cabinet 100 to be tested. The device 10 can include an angle tester 11, a controller 12, and a driver 13. The machine cabinet 100 is carried on the driver 13. The device 10 can be used to test a tilt angle of the machine cabinet 100.

The angle tester 11 can include a sensor 14 and a dial 15 connected to the sensor 14. The sensor 14 can be connected to the machine cabinet 100, and used to sense the tilt angle of the machine cabinet 100. The dial 15 can include a preset pointer 150 and a test pointer 151. The preset pointer 150 can be pointed to a preset angle during testing. The test pointer 151 can point to an actual angle of tilt angle of the machine cabinet 100.

The controller 12 can include a processor 16 and a plurality of components connected to the processor 16, such as a preset angle module 17, a tilt angle display 18, a test button 19, a reset button 20, a first switch 21, and a second switch 22. The preset angle module 17 can include a keyboard 170, a preset angle display 171, and a storage 172. A value of the preset angle of the machine cabinet 100 can be preset through the keyboard 170, stored in the storage 172, and shown on the preset angle display 171. In the embodiment, the first and second switches 21 and 22 are n-channel metal oxide semiconductor field-effect transistors (NMOSFETs).

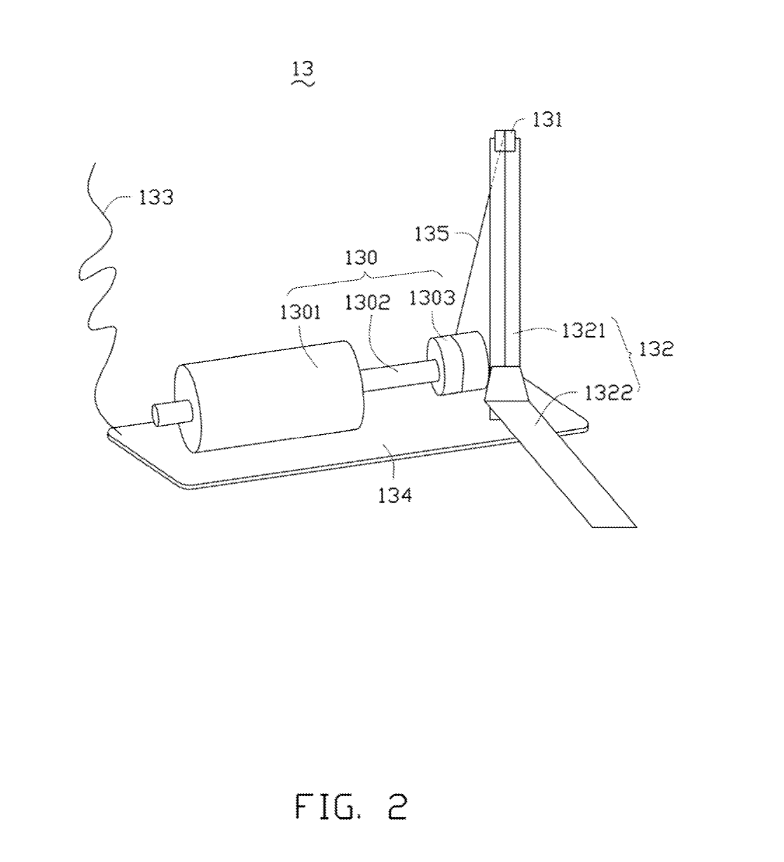

FIG. 2 illustrates an embodiment of the driver 13. The driver 13 can include a motor 130, a crown block 131, a lifter 132, and a lifting chain 135. The motor 130 can include a main body 1301 fixed on a base board 134 and connected to the processor 16 through a power cable 133, a transmission wheel 1303, and a shaft 1302 connecting the main body 1301 and the transmission wheel 1303. The lifter 132 can include a mast 1321 fixed on the base board 134 and a bracket 1322 adjacent to the bottom of the mast 1321. The crown block 131 is on the top of the mast 1321. A first end of the lifting chain 135 is fixed to the transmission wheel 1303. A second end of the lifting chain 135 is fixed on the bracket 1322 through the crown block 131. When the main body 1301 of the motor 130 receives a signal to rotate positively, both of the shaft 1302 and the transmission wheel 1303 rotate in a clockwise direction. The rotation of the transmission wheel 1303 causes the lifting chain 135 to roll, which causes the bracket 1322 to move up. When the main body 1301 of the motor 130 receives a signal to rotate in reverse, both of the shaft 1302 and the transmission wheel 1303 rotate in an anticlockwise direction. The bracket 1322 is dragged to move down through the transmission wheel 1303 so releasing the tension in lifting chain 135. The main body 1301 receives a test order or a reset order from the processor 16 through the power cable 133.

The power cable 133 includes a live line and a neutral line 332. The live line is composed of a first winding 330 and a second winding 331. A gate of the first switch 21 is connected to the processor 16. A drain of the first switch 21 is connected to the first winding 330 of the live line. A source of the first switch 21 is connected to the neutral line 332. A gate of the second switch 22 is connected to the processor 16. A drain of the second switch 22 is connected to the second winding 331 of the live line. A source of the second switch 22 is connected to the neutral line 332.

During testing, a first end of a bottom of the machine cabinet 100 is placed on a distal end portion of the bracket 1322 of the driver 13, the driver 13 being on a flat and level surface, such as a floor. A second end of the bottom of the machine cabinet 100 is placed on a flat and level surface. When the test button of the controller 12 is pressed, the processor 16 receives a test order from the test button 19, and outputs a digital logic-high signal to the first switch 21. The first switch 21 is turned on. The neutral line 332 of the power cable 133 is connected to the first winding 330. The transmission wheel 1303 and the crown block 131 rotate in the clockwise direction to make the bracket 135 move up through the transmission wheel 1303 to advance the lifting chain 135. The first end of the bottom of the machine cabinet 100 is lifted up. The tilt angle is the angle between the bottom of the machine cabinet 100 and the flat and level surface tilt angle.

The processor 16 receives the tilt angle of the machine cabinet 100 sensed by the sensor 14 of the angle tester 11. The test pointer 151 points to the tilt angle indicated by the sensor 14. The tilt angle display 18 shows a current tilt angle of the machine cabinet 100. The processor 16 compares the tilt angle of the machine cabinet 100 with the preset angle. If the tilt angle is not equal to the preset angle, the processor 16 controls the driver 13 to continue rotating along the clockwise direction. The first end of the bottom of the machine cabinet 100 is lifted up by the crown block 131 and the transmission wheel 1303, until the test pointer 151 matches the preset pointer 150, i.e., the tilt angle equals the preset angle. When the tilt angle equals the preset angle, the processor 16 outputs a logic-low signal to the first switch 21. The first switch 21 is turned off The neutral line 332 of the power cable 133 is disconnected from the first winding 330. The motor 130 stops operation. The value of the tilt angle of machine cabinet 100 is displayed on the tilt angle display 18. If the machine cabinet 100 does not topple at this time, the machine cabinet 100 meets the standard.

When the reset button 20 of the controller is pressed, the processor 16 outputs a logic-high signal to the second switch 22, according to a reset signal from the reset button 20. The second switch 22 is turned on. The neutral line 332 of the power cable 133 is connected to the second winding 331. The transmission wheel 1303 rotates in the anticlockwise direction. The bracket 1322 is dragged to move down through the transmission wheel 1303 to release the tension in lifting chain 135.

Thus, the tilt angle of the machine cabinet 100 is tested.

While the disclosure has been described by way of example and in terms of preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A device for testing a tilt angle of a machine cabinet, the device comprising:
an angle tester comprising a sensor connected to the machine cabinet to sense the titling angle of the machine cabinet;
a controller comprising a processor connected to the sensor, a preset angle module setting a preset angle, a test button sending a test order to the processor, and a tilt angle display; and
a driver connected to the processor, carrying and driving the machine cabinet to tilt according to the test order sent from the test button;
wherein when the test button of the controller is pressed, the processor controls the driver to rotate along a clockwise direction according to the test order, and drives the machine cabinet to tilt; the processor compares the sensed tilt angle with the preset angle, if the tilt angle is different from the preset angle, the processor controls the driver to continue rotating along the clockwise direction; if the tilt angle equals to the preset angle, the processor controls the driver to stop rotation, and the value of the tilt angle of machine cabinet is displayed on the tilt angle display.

2. The device of claim 1, wherein the controller further comprises a reset button connected to the processor, after the driver stops rotation, the processor controls the driver to rotate along an anticlockwise direction according to a reset order sent by pressing the reset button, and the driver drives the machine cabinet to restore to an initial position.

3. The device of claim 1, wherein the driver comprises a motor, a crown block, a lifter fixing the crown block, and a lifting chain, the motor comprises a main body fixed on a base board and connecting to a power cable, a transmission wheel, and a shaft; the lifter comprises a mast fixed on the base board and a bracket adjacent to a bottom of the mast, the crown block is on a top of the mast, a first end of the lifting chain is fixed to the transmission wheel, a second end of the lifting chain is fixed to the bracket through the crown block, when the main body of the motor receives a signal of positive rotation, the shaft and the transmission wheel rotate in the clockwise direction, the bracket is dragged to move up through the transmission wheel rolling the lifting chain; and when the main body of the motor receives a signal of converse rotation, the transmission wheel rotates in the anticlockwise direction, and the bracket is dragged to move down through the transmission wheel releasing the lifting chain.

4. The device of claim 3, wherein the controller further comprises a first switch and a second switch, the power cable comprises a live line and a neutral line, the live line is composed of a first winding and a second winding, a first terminal of the first switch is connected to the processor, a second terminal of the first switch is connected to the first winding of the live line, a third terminal of the first switch is connected to the neutral line; a first terminal of the second switch is connected to the processor, a second terminal of the second switch is connected to the second winding of the live line, a third terminal of the second switch is connected to the neutral line; when the processor receives the test order from the test button, the first switch is controlled to turned on by the processor, the motor of the driver rotates in the clockwise direction, when the processor receives the reset order from the reset button, the second switch is controlled to turned on by the processor, and the motor of the driver rotates in the anticlockwise direction.

5. The device of claim 1, wherein the preset angle module comprises a keyboard, a preset angle display, and a storage, and the preset angle is preset through the keyboard, stored in the storage, and displayed on the preset angle display.

6. The device of claim 1, wherein the angle tester further comprises a test pointer and a preset pointer on a dial, the test pointer connected to the sensor, and pointing to a corresponding tilt angle on the dial, when the tilt angle is the same as the preset angle, the test pointer superposes the preset pointer.
